(19) United States
(12) Patent Application Publication
(10) Pub. No.: US 2011/0096265 A1
(43) Pub. Date: Apr. 28, 2011

(54) BACKLIGHT UNIT AND DISPLAY DEVICE INCLUDING THE SAME

(76) Inventors: Kenichi MURAKOSHI, Osaka (JP); Yasuaki HIRANO, Osaka (JP); Nobuo OGATA, Osaka (JP); Shinji SUMINOE, Osaka (JP); Mitsuru HINENO, Osaka (JP); Yoshihisa SEKIGUCHI, Osaka (JP); Takafumi OHATA, Osaka (JP); Makoto HIROTA, Osaka (JP)

(21) Appl. No.: 12/825,603

(22) Filed: Jun. 29, 2010

(30) Foreign Application Priority Data
Oct. 26, 2009 (JP) 2009-245132

(51) Int. Cl. G02F 1/13357

(52) U.S. Cl. 349/64; 362/97.2

(57) ABSTRACT

Provided is a backlight unit capable of increasing luminance and of reducing unevenness in luminance. The backlight unit includes: a light diffusing member provided to cover a light emitting element mounted on a surface of a substrate; and a first light reflective member having a hole portion opened larger in size than an outer shape of the light diffusing member, the first light reflective member being provided on the surface of the substrate while having the light diffusing member protrude from the hole portion. In addition, a second light reflective member is further provided on the surface of the substrate, and the second light reflective member covers at least a part of a region corresponding to a gap left between the light diffusing member and the hole portion of the first light reflective member.

The present application claims priority from Japanese Patent Application No. 2009-245132 filed on Oct. 26, 2009, the content of which is hereby incorporated by reference into this application.

### BACKGROUND OF THE INVENTION

1. Field of the Invention

The present invention relates to a backlight unit and a display device including the same.

2. Description of the Related Art

A liquid crystal display device, which is a kind of a display device, includes a liquid crystal display panel for displaying an image. The liquid crystal display panel does not emit light, and hence a backlight unit is installed on a rear surface side (side opposite to a display surface side of the liquid crystal display panel) of the liquid crystal display panel so that the liquid crystal display panel is illuminated by the backlight unit, to thereby enable display operation.

As a light source to be used for the backlight unit, there is known a cold cathode fluorescent lamp formed of a fluorescent tube sealing mercury or xenon therein. However, when the cold cathode fluorescent lamp is employed as the light source for the backlight unit, there has been suffered inconvenience as follows. That is, the cold cathode fluorescent lamp fails to attain a sufficient light-emitting luminance and life. In particular, the luminance on a low-pressure side is lowered, which makes it difficult to attain well-balanced luminance.

In order to resolve the above-mentioned inconvenience, there is proposed a backlight unit which employs, as the light source, a light emitting diode (LED) instead of the cold cathode fluorescent lamp. Such a backlight unit is disclosed, for example, in JP 2007-180005 A. When the LED is employed as the light source as in the backlight unit thus proposed, a high luminance may be attained with low power consumption. In addition, environmental load may also be reduced.

It should be noted that there are various methods of producing white light by using LED. For example, one of the methods is to use a phosphor which converts blue LED light into yellow light, in combination with a blue LED. Another one is to use phosphors converting blue LED light into green light and red light, respectively, in combination with a blue LED. There is still another method which uses three kinds of LEDs, namely, a blue LED, a green LED, and a red LED in combination.

The backlight unit generally falls into two types, namely, a side light type and a direct light type.

A backlight unit of side light type includes a light guide plate disposed immediately below the liquid crystal display panel, and a light source disposed so as to oppose to a predetermined side edge surface of the light guide plate. In the backlight unit of side light type, when the light source emits light, the light from the light source is introduced into the light guide plate via the predetermined side edge surface of the light guide plate. Then, the light introduced into the light guide plate is emitted from a top surface (surface facing toward the liquid crystal display panel side) of the light guide plate in a planar manner, resulting that the liquid crystal display panel is illuminated. The light guide plate has an optical pattern formed on a rear surface (surface opposite to the top surface). When the light introduced into the light guide plate propagates toward the rear surface side of the light guide plate, the optical pattern changes the traveling direction of the light so as to be directed toward the top surface side of the light guide plate.

On the other hand, a backlight unit of direct light type has a light source disposed immediately below the liquid crystal display panel. The backlight unit of direct light type configured as described above demonstrates an advantage in illuminating a large area on high power, and is generally used in a large-size liquid crystal display device.

In the following, with reference to FIG. 11, a description is given of a configuration example of a conventional backlight unit of direct light system which employs an LED as a light source. FIG. 11 is an enlarged cross sectional view illustrating a part of the conventional backlight unit.

In the conventional backlight unit, as illustrated in FIG. 11, a plurality of LEDs 102 are mounted on a surface of a mounting board 101, and the plurality of LEDs 102 are each individually covered with an optical lens (member for diffusing light generated by the LED 102) 103. A reflective sheet 104 is provided on the surface of the mounting board 101 so that the surface of the mounting board 104 is covered therewith. The reflective sheet 104 has a plurality of hole portions 104a (which is the same in number with the LEDs 102) formed therein, and the optical lens 103 (LED 102) protrudes from each of the hole portions 104a of the reflective sheet 104 in a state where the reflective sheet 104 is provided on the surface of the mounting board 101. Further, optical sheets including a diffusing plate 105 (not shown except for the diffusing plate 105) are provided at a predetermined distance away from the surface of the mounting board 101.

In the conventional backlight unit as illustrated in FIG. 11, the hole portion 104a of the reflective sheet 104 is opened larger in diameter than an outer shape of the optical lens 103. In other words, a gap G is left between the optical lens 103 and the hole portion 104a of the reflective sheet 104 when the reflective sheet 104 is provided.

In this case, light L generated by the LED 102 is iteratively reflected between the mounting board 101 and the diffusing plate 105, and hence the light L may enter the gap G left between the optical lens 103 and the hole portion 104a of the reflective sheet 104. When the light L enters the gap G as described above, the light L is absorbed by the surface of the mounting board 101, leading to an inconvenience that the light L is attenuated and the luminance is lowered.

Further, the entire surface of the mounting board 101 is dotted with the gaps G each left between the optical lens 103 and the hole portion 104a of the reflective sheet 104. Accordingly, an increased amount of light absorbed by the gaps G results in unevenness in luminance.

### SUMMARY OF THE INVENTION

The present invention has been made in order to solve the above-mentioned problems, and therefore, it is an object of the invention to provide a backlight unit capable of increasing luminance and of reducing unevenness in luminance, and a display device including the same.

In order to achieve the above-mentioned object, a backlight unit according to a first aspect of the present invention includes: a substrate; a light emitting element mounted on a surface of the substrate; a light diffusing member provided on the surface of the substrate so that the light emitting element is covered with the light diffusing member; a first light reflective member having a hole portion opened larger in size than an outer shape of the light diffusing member, the first light reflective member being provided on the surface of the substrate while having the light diffusing member protrude from the hole portion so that the first light reflective member covers the surface of the substrate; and a second light reflective member further provided on the surface of the substrate, the second light reflective member being a member different from the first light reflective member. The light diffusing member and the hole portion of the first light reflective member have a gap left therebetween, and the second light reflective member covers at least a part of a region of the surface of the substrate, the region corresponding to the gap.

In the backlight unit according to the first aspect, in the case where the gap is left between the light diffusing member and the hole portion of the first light reflective member as described above, the second light reflective member, which is a member different from the first reflective member, is further provided on the surface of the substrate, to thereby cover a region corresponding to the gap on the surface of the substrate at least in part with the second light reflective member. Accordingly, even when light generated by the light emitting element has entered the gap, the region corresponding to the gap on the surface of the substrate is covered at least in part with the second light reflective member, and hence the light is hardly absorbed by the region corresponding to the gap on the surface of the substrate. As a result, luminance may be increased while reducing unevenness in luminance.

In the backlight unit according to the first aspect, the second light reflective member is preferred to be formed of a material obtained by further adding a predetermined light reflective material to a white solder resist. It should be noted that the predetermined light reflective material to be further added to the white solder resist may be any material as long as a total reflectivity of equal to or larger than 90% may be attained in the second light reflective member. Such a material may include, for example, a rutile type titanium oxide. With this configuration, an amount of light propagating in a desired direction may be increased as being reflected by the second reflective member, which may further increase luminance.

In the backlight unit according to the first aspect, the second light reflective member is preferred to extend from the region on the surface of the substrate, the region corresponding to the gap, to another region on the surface of the substrate, the another region overlapping an inner edge portion of the hole portion of the first light reflective member. With this configuration, the inner edge portion of the hole portion of the first light reflective member overlaps the second light reflective member, and hence a region in proximity to the inner edge portion of the hole portion of the first light reflective member is not exposed on the surface of the substrate. In other words, an area absorbing light may be reduced.

In the backlight unit according to the first aspect, the second light reflective member is preferred to have an opening portion formed therein, the opening portion being for exposing a region where the light diffusing member is installed on the surface of the substrate. With this configuration, even when the second light reflective member is provided on the surface of the substrate, the light diffusing member may be installed with ease onto the surface of the substrate.

In this case, the light diffusing member is preferred to have a fixing portion fixed onto the surface of the substrate, and the opening portion of the second light reflective member is preferred to have a shape formed along a shape of the fixing portion of the light diffusing member. With this configuration, when fixing the light diffusing member onto the surface of the substrate, the opening portion of the second light reflective member serves as a mark to be used for placing the light diffusing member. Accordingly, the light diffusing member may be positioned with ease.

In the backlight unit according to the first aspect, the light emitting element comprises a plurality of light emitting elements and the light diffusing member comprises a plurality of light diffusing members. The plurality of light emitting elements are preferred to be arranged two-dimensionally and mounted on the surface of at least one of the substrate, and the plurality of light diffusing members respectively covering the plurality of light emitting elements are preferred to be provided on the surface of the at least one substrate. Further, one of the first light reflective member is preferred to have a plurality of the hole portion formed therein so that the surface of the at least one substrate is covered with the one first light reflective member. With this configuration, only one light reflective member is used, and hence the assembly man hours and assembly cost may be reduced.

In the backlight unit according to the first aspect, the light diffusing member is preferred to include an optical lens. The firsts light reflective member is preferred to include a reflective sheet. Further, the light emitting element is preferred to include a white light emitting diode. With this configuration, the backlight unit may be reduced in size and thickness with ease.

Further, a display device according to a second aspect of the present invention includes: a display panel; and a backlight unit for illuminating the display panel. The backlight unit includes: a substrate; a light emitting element mounted on a surface of the substrate; a light diffusing member provided on the surface of the substrate so that the light emitting element is covered with the light diffusing member; a first light reflective member having a hole portion opened larger in size than an outer shape of the light diffusing member, the first light reflective member being provided on the surface of the substrate while having the light diffusing member protrude from the hole portion so that the first light reflective member covers the surface of the substrate; and a second light reflective member further provided on the surface of the substrate, the second light reflective member being a member different from the first light reflective member. The light diffusing member and the hole portion of the first light reflective member have a gap left therebetween, and the second light reflective member covers at least a part of a region of the surface of the substrate, the region corresponding to the gap. With this configuration, luminance may be increased while reducing unevenness in luminance with ease.

### BRIEF DESCRIPTION OF THE DRAWINGS

In the accompanying drawings:

FIG. 1 is an exploded perspective view of a liquid crystal display device including a backlight unit according to an embodiment of the present invention;

FIG. 2 is a perspective view for illustrating shapes of an optical lens and a reflective sheet included in the backlight unit according to the embodiment;

FIG. 3 is a plan view illustrating a gap left between the optical lens and a hole portion of the reflective sheet included in the backlight unit according to the embodiment;

FIG. 4 is an enlarged cross sectional view illustrating a part of the backlight unit according to the embodiment;

FIG. 5 is a plan view illustrating a placement position of a light reflective member (white solder resist containing a high light reflective material) included in the backlight unit according to the embodiment;

FIG. 6 is a cross sectional view illustrating a behavior of light inside the backlight unit according to the embodiment;

FIG. 7 is a plan view for illustrating a result of measurement performed for confirming an effect of the embodiment;

FIG. 8 is a graph for illustrating another result of measurement performed for confirming the effect of the embodiment;

FIG. 9 is a graph for illustrating a still another result of measurement performed for confirming the effect of the embodiment;

FIG. 10 is a graph for illustrating a still another result of measurement performed for confirming the effect of the embodiment; and

FIG. 11 is an enlarged cross sectional view illustrating a part of a conventional backlight unit.

### DETAILED DESCRIPTION OF THE PREFERRED EMBODIMENTS

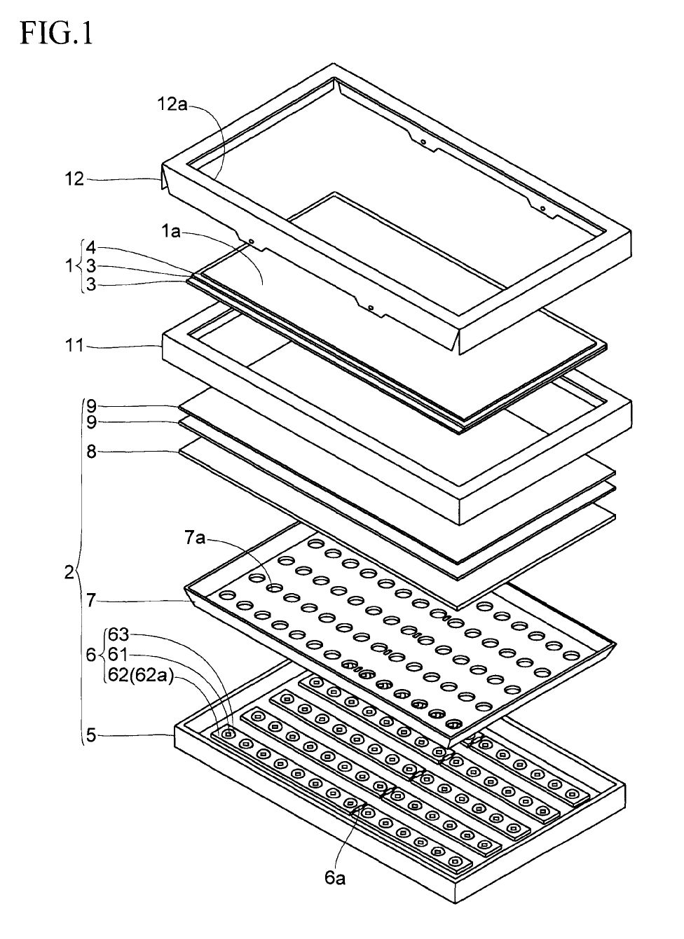

First, with reference to FIGS. 1 to 5, a configuration of a display device according to an embodiment of the present invention is described in detail.

The display device is a liquid crystal display device, and includes, as illustrated in FIG. 1, a liquid crystal display panel (display panel) 1 having a display surface 1a, and a backlight unit 2 of direct light type, which is installed on a rear surface (surface opposite to the display surface 1a) side of the liquid crystal display panel 1.

The liquid crystal display panel 1 includes at least a liquid crystal layer (not shown), a pair of glass substrates 3, and a polarizing plate 4. The pair of glass substrates 3 are attached to each other across a seal material (not shown), and have a liquid crystal layer sandwiched therebetween. The polarizing plate 4 is disposed on each surface opposite to the liquid crystal layer side, of the pair of glass substrates 3. It should be noted that FIG. 1 illustrates only the polarizing plate 4 located on the display surface 1a side of the liquid crystal display panel 1.

The backlight unit 2 includes at least a back chassis 5, a light emitting module 6, a reflective sheet 7, a diffusing plate 8, and optical sheets 9. It should be noted that the reflective sheet 7 is an example of a “first light reflective member” of the present invention.

The back chassis 5 may be obtained by processing a metallic plate-like member, and is formed in a substantially box shape which opens on the liquid crystal display panel 1 side. In other words, the back chassis 5 has a bottom portion and side portions vertically formed along the periphery of the bottom portion. Further, a region surrounded by the side portions of the back chassis 5 is in a substantially rectangular shape, and the substantially rectangular region defines a receiving region.

The light emitting module 6 generates illumination light (light for illuminating the liquid crystal display panel 1). A plurality of the light emitting modules 6 are received in the receiving region of the back chassis 5. The plurality of the light emitting modules 6 are arranged two-dimensionally in a longitudinal direction and in a lateral direction of the back chassis 5 at predetermined intervals. The light emitting modules 6 that are next to each other in the longitudinal direction of the back chassis 5 are electrically connected via a connector 6a. Then, the light emitting modules 6 are arranged so as to be disposed directly below the liquid crystal display panel 1 (in a region opposing to the rear surface of the liquid crystal display panel 1) when the backlight unit 2 is installed on the rear surface side of the liquid crystal display panel 1.

Further, the light emitting modules 6 each include at least a white light emitting diode (LED) 61 and a mounting board 62. A predetermined number of LEDs 61 are mounted on a mounting surface (surface) of one mounting board 62, so as to be modularized. Specifically, the mounting board 62 has a land (not shown) formed on the mounting surface thereof, and the white LEDs 61 are fixed via solder onto the land on the mounting surface of the mounting board 62. It should be noted that the white LED 61 is an example of a “light emitting element” of the present invention, and the mounting board 62 is an example of a “substrate” of the present invention.

The mounting board 62 onto which the white LEDs 61 are mounted has a mounting surface in a substantially rectangular shape. The mounting board 62 has a solder mask layer 62a formed on the mounting surface side thereof, so that a metallic pattern (wiring for connecting the plurality of white LEDs 61 in series), which is formed on the mounting surface side of the mounting board 62, may be protected from an external impact or a corrosive material. In general, the solder mask layer 62a formed on the mounting surface side of the mounting board 62 is often colored green. However, the solder mask layer 62a may be colored white in order to increase a light reflectivity in the mounting surface of the mounting board 62.

The light emitting modules 6 each further includes an optical lens 63 for diffusing light from the white LEDs 61. The optical lens 63, which is made of a polymethylmethacrylate (PMMA) resin, is formed to be substantially circular in outer shape in plan view (when viewed in a planar direction from a normal direction of the mounting surface of the mounting board 62). The optical lenses 63 are assigned one by one to each of the white LEDs 61, and the optical lenses 63 are each fixed onto the mounting surface of the mounting board 62 via an adhesive (for example, a thermosetting epoxy adhesive resin) so as to cover a light emitting surface side of the white LED 61. With this configuration, light from the white LED 61 is scattered by the optical lens 63, and hence the thickness of the backlight unit 2 may be reduced, with the result that the liquid crystal display device may be reduced in thickness.

Meanwhile, the number of the light emitting modules 6 received in the back chassis 5 is not specifically limited, and may be varied depending on the intended use. Further, the number of white LEDs 61 mounted on the mounting surface of one mounting board 62 may not be specifically limited.

Further, a plurality of types of the light emitting modules 6 which are different from each other in number of white LEDs 61 mounted thereon (for example, three types of the light emitting modules 6 each having five white LEDs 61, six white LEDs 61, and eight white LEDs 61 mounted thereon, respectively) may be provided, and the plurality of types of the light emitting modules 6 may be used in combination. When the plurality of types of the light emitting modules 6 are provided as described above, a light emitting area may be changed in size merely by adjusting the combination and the number of the plurality of types of the light emitting modules 6 to be connected. Specifically, in a case of changing a panel size (size of a display area), the combination and the number of the plurality of types of the light emitting modules 6 to be connected may be adjusted so as to be adapted to the change in panel size. Accordingly, there is no need to newly manufacture the light emitting modules 6 adjusted to the change in panel size, which leads to cost reduction.

It should be noted that, in this embodiment, two types of the light emitting modules 6 each having six white LEDs 61 and eight white LEDs 61 mounted thereon, respectively, are used in combination, and the two types of the light emitting modules 6 are electrically connected to each other via the connector 6a.

The reflective sheet 7 is obtained by processing a sheet member made of a resin, and has a bottom portion and side portions vertically formed along the periphery of the bottom portion. The bottom portion has a plurality of hole portions 7a each being substantially circular in opened shape in plan view. The reflective sheet 7 is received, together with the light emitting modules 6, in the receiving region of the back chassis 5 so that the optical lenses 63 (white LEDs 61) protrude from the hole portions 7a. In other words, the bottom portion of the back chassis 5 and the mounting surface of the mounting board 62 are covered with the bottom portion of the reflective sheet 7, while the back chassis 5 has inner side surfaces covered with the side portions of the reflective sheet 7. The reflective sheet 7 thus provided reflects light, which increases an amount of light propagating toward the liquid crystal display panel 1 side, with the result that the light use efficiency is improved.

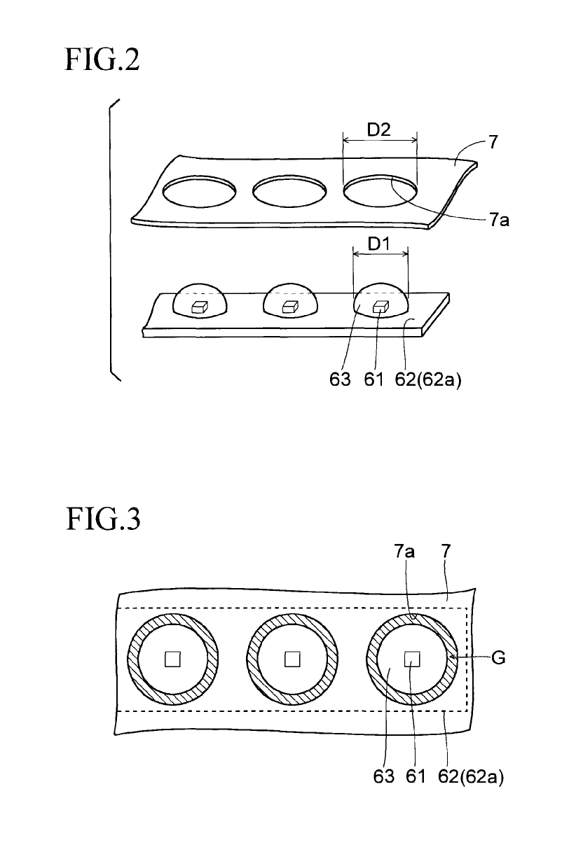

As illustrated in FIG. 2, each of the hole portions 7a formed in the reflective sheet 7 is opened larger in diameter than the outer shape of the optical lens 63. In other words, an opening diameter D2 of the hole portions 7a of the reflective sheet 7 is larger than an outer diameter D1 of the optical lenses 63. The hole portions 7a of the reflective sheet 7 are each opened larger in diameter, in order to avoid trouble which may arise in installing the reflective sheet 7 (trouble in having the optical lenses 63 protrude from the hole portions 7a of the reflective sheet 7) in a case where the optical lenses 63 (white LEDs 61) exhibit fluctuations in forming dimension and mounting position for mounting the optical lenses 63 (white LEDs 61) on the mounting surface of the mounting board 6. It should be noted that, in a case where the opening diameter D2 of the hole portions 7a of the reflective sheet 7 is made equal to the outer diameter D1 of the optical lenses 63, the reflective sheet 7 may not be installed when the optical lenses 63 (the white LEDs 61) exhibit a wide range of fluctuation in forming dimension and mounting position.

Further, the opening diameter D2 of the hole portions 7a of the reflective sheet 7 needs to be determined with consideration given to a difference in coefficient of thermal expansion among the back chassis 5, the reflective sheet 7, the mounting board 62, and the optical lens 63. In a case where the difference in coefficient of thermal expansion is large, the optical lens 63 and the hole portion 7a of the reflective sheet 7 change in relative position due to temperature changes, and come into contact with each other. As a result, a stress is generated between the optical lens 63 and the reflective sheet 7. Then, the stress results in distortion in the reflective sheet 7, and the distortion in the reflective sheet 7 leads to unevenness in luminance. In other words, the difference in coefficient of thermal expansion among the back chassis 5, the reflective sheet 7, the mounting board 62, and the optical lens 63 is one of the important reasons for increasing the opening diameter D2 of the hole portions 7a of the reflective sheet 7.

Due to the reason as described above, the hole portions 7a of the reflective sheet 7 are each opened larger in diameter. In this case, however, as illustrated in FIG. 3, a gap (hatched region of FIG. 3) G is left between the optical lens 63 and the hole portion 7a of the reflective sheet 7 in plan view. In other words, a region not covered with the reflective sheet 7 is left.

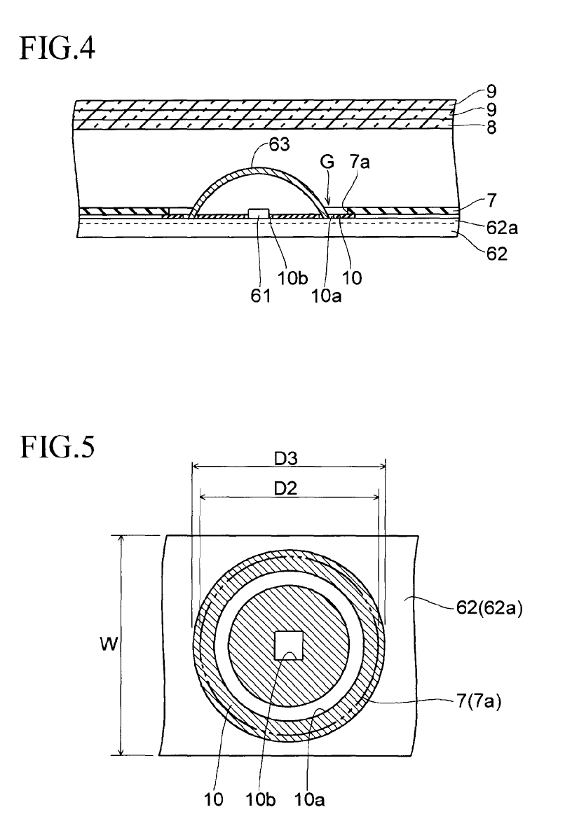

In view of the above, according to this embodiment, as illustrated in FIGS. 4 and 5, a light reflective member 10 is further provided on the mounting surface of the mounting board 62. The light reflective member 10 is independently disposed on each of a plurality of regions corresponding to the hole portions 7a of the reflective sheet 7, to thereby cover a region corresponding to the gap G on the mounting surface of the mounting board 62 with the light reflective member 10. It should be noted that the light reflective member 10 is an example of a “second light reflective member” of the present invention.

The light reflective member 10 is formed of a material obtained by further adding a high light reflective material having a high light reflectivity (for example, rutile type titanium oxide) to a white solder resist. The material is applied onto the mounting surface of the mounting board 62 by printing, to thereby form the light reflective member 10. Further, the light reflective member 10 is designed to have a thickness of about 60 μm to 70 μm, so that light may be satisfactorily reflected.

Further, the light reflective member 10 is formed to be substantially circular in outer shape in plan view, and has an outer diameter D3 formed larger than the opening diameter D2 of the hole portion 7a of the reflective sheet 7. In other words, the light reflective member 10 has a peripheral edge portion extended from a region corresponding to the gap G to a region overlapping an inner edge portion of the hole portion 7a of the reflective sheet 7, so that the peripheral edge portion of the light reflective member 10 overlaps the inner edge portion of the hole portion 7a of the reflective sheet 7. With this configuration, the light reflective member 10 reliably covers a region in proximity to the inner edge portion of the hole portion 7a of the reflective sheet 7 on the mounting surface of the mounting board 62.

The outer diameter D3 of the light reflective member 10 is determined in view of, for example, print precision of the white solder resist containing a high light reflective material, s in forming dimension of the hole portions 7a of the reflective sheet 7, and mounting tolerance of the reflective sheet 7. It should be noted that, in a case of using the mounting board 62 in a strip shape, a length W of the mounting board 62 in a lateral direction thereof needs to be larger than the outer diameter D3 of the light reflective member 10.

Further, the light reflective member 10 has an opening portion 10a for exposing a region to which the optical lens 63 is fixed on the mounting surface of the mounting board 62. The opening portion 10a of the light reflective member 10 has a shape formed along a shape of a fixing portion for the optical lens 63 (portion at which the optical lens 63 is fixed onto the mounting surface of the mounting board 62). That is, the opening portion 10a is formed to be substantially annular in shape in plan view. Further, the light reflective member 10 also has an opening portion 10b for exposing a region onto which the white LED 61 is mounted on the mounting surface of the mounting board 62. Opening dimensions of the opening portions 10a and 10b of the light reflective member 10 are determined in view of, for example, print precision of the white solder resist containing a high light reflective material, and mounting tolerance of the white LEDs 61 and the optical lenses 63.

Further, as illustrated in FIG. 1, the diffusing plate 8 is formed of a plate-like member made of a resin, and covers the opening of the back chassis 5 on the liquid crystal display panel 1 side. In other words, the light emitting modules 6 are covered with the diffusing plate 8 from the liquid crystal display panel 1 side. With this configuration, light from the light emitting modules 6 is diffused by the diffusing plate 8 before illuminating the liquid crystal display panel 1.

The optical sheets 9 are each formed of a sheet-like member made of a resin, which is smaller in thickness than the diffusing plate 8. The optical sheets 9 are disposed on the liquid crystal display panel 1 side of the diffusing plate 8. The optical sheets 9 are used to diffuse and collect light passed through the diffusing plate 8. It should be noted that the optical sheets 9 to be used may be varied in type depending on the intended use.

In this embodiment, the backlight unit 2 configured as described above is installed in a liquid crystal display device.

Further, a frame 11 made of a resin is disposed between the liquid crystal display panel 1 and the backlight unit 2. The frame 11 is formed in a shape of frame. A frame portion of the frame 11 presses outer edge portions of the optical sheets 9, to thereby hold a laminated body which includes the diffusing plate 8 and the optical sheets 9 laminated in the stated order.

Further, a bezel 12 made of metal is disposed on the display surface 1a side of the liquid crystal display panel 1. The bezel 12 forms a receiving member, together with the back chassis 5. The bezel 12 has a top surface in which an opening portion 12a is formed and side portions vertically formed along the periphery of the top surface. The side portions of the bezel 12 are assembled to the side portions of the back chassis 5 so that the bezel 12 is fixed to the back chassis 5. Further, the display surface 1a of the liquid crystal display panel 1 is exposed at the opening portion 12a of the bezel 12.

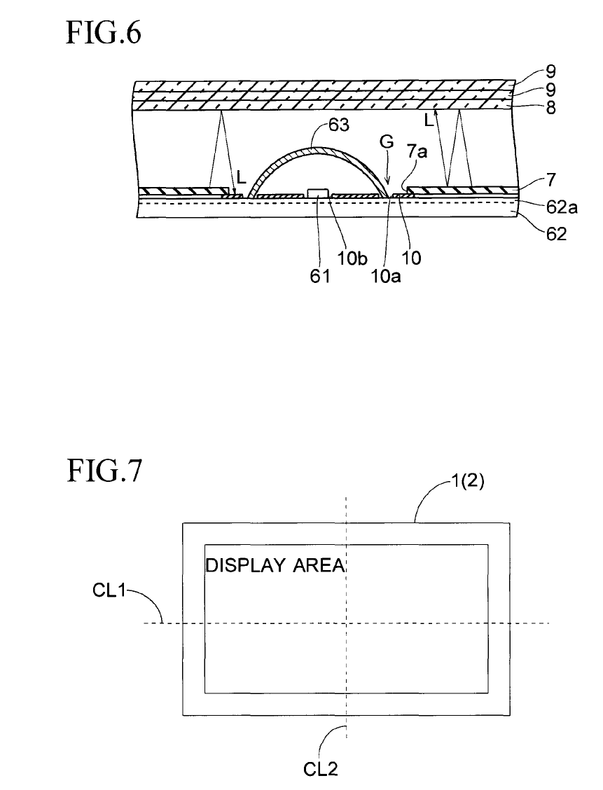

In this embodiment, as described above, a region corresponding to the gap G on the mounting surface of the mounting board 62 is covered with the light reflective member 10, and further the light reflective member 10 is formed of a material made of a white solder resist containing a high light reflective material having a high light reflectivity. Accordingly, as illustrated in FIG. 6, even when light L generated by the white LED 61 has entered the gap G, a region corresponding to the gap G on the mounting surface of the mounting board 62 (generally, solder mask layer 62a) is covered with the light reflective member 10, and hence the light L entered the gap G is reflected toward the diffusing plate 8 side with being hardly absorbed. With this configuration, luminance may be increased while reducing unevenness in luminance. It should be noted that, in this embodiment, the mounting surface of the mounting board 62 is exposed at a region in proximity to the peripheral portion of the optical lens 63. However, the area thus exposed is very small, and hence absorbs little light.

Here, in order to confirm the above-mentioned effect, the liquid crystal display device according to the embodiment (in which the light reflective member 10 formed of a white solder resist containing a high light reflective material is disposed on a region corresponding to the gap G on the mounting surface of the mounting board 62) and a liquid crystal display device as an comparative example (in which the mounting surface of the mounting board 62 (generally, the solder mask layer 62a) is exposed across an entire region of the gap G) were manufactured, and the luminance characteristics thereof were measured to obtain the following results. It should be noted that the measurement was performed, subjecting to conditions provided below. That is, the measurement was performed in a dark room by using a two-dimensional luminance colorimeter (CA-2000) manufactured by Konica Minolta, the panel size was 40-inch, and a current value flowing through the white LED 62 was set to 60 mA.

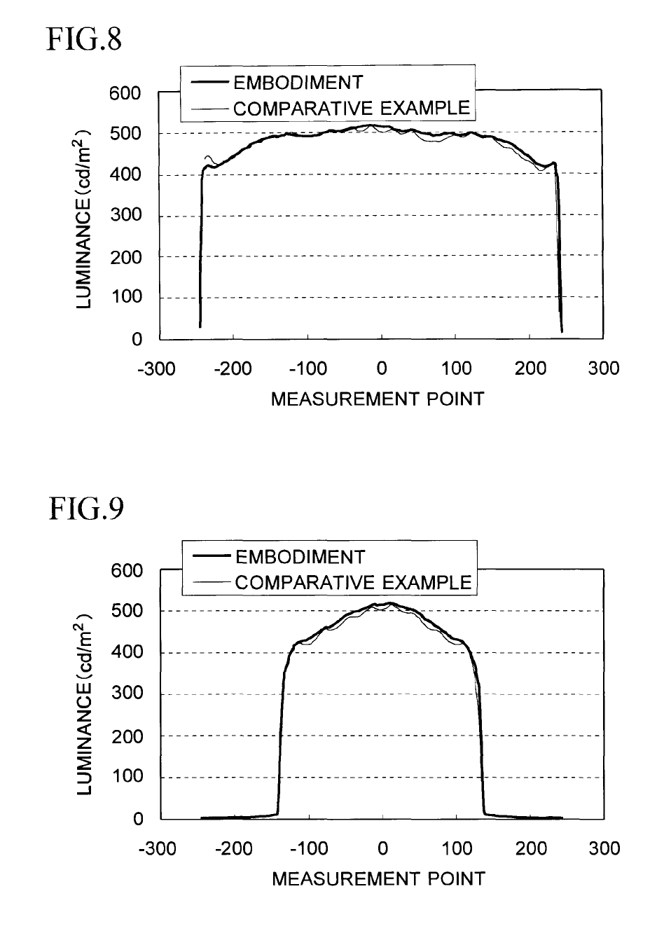

Specifically, according to this embodiment, the luminance distribution illustrated by the bold line of FIG. 8 was obtained on a central line CL 1 (see FIG. 7), and the luminance distribution illustrated by the bold line of FIG. 9 was obtained on a central line CL 2 (see FIG. 7). On the other hand, according to the comparative example, the luminance distribution illustrated by the thin line of FIG. 8 was obtained on the central line CL 1 (see FIG. 7), and the luminance distribution illustrated by the thin line of FIG. 9 was obtained on the central line CL 2 (see FIG. 7).

Specifically, the bold line illustrating the luminance distribution of this embodiment has little irregularities, while the thin line illustrating the luminance distribution of the comparative example has many irregularities. Accordingly, it was confirmed that unevenness in luminance was reduced in this embodiment as compared with the comparative example.

Further, maximum values of the luminances of this embodiment and the comparative example were respectively obtained. The luminance according to this embodiment had a maximum value of 505.2 cd/m² while the luminance according to the comparative example had a maximum value of 456.1 cd/m². Accordingly, it was also confirmed that light loss was reduced in this embodiment as compared with the comparative example.

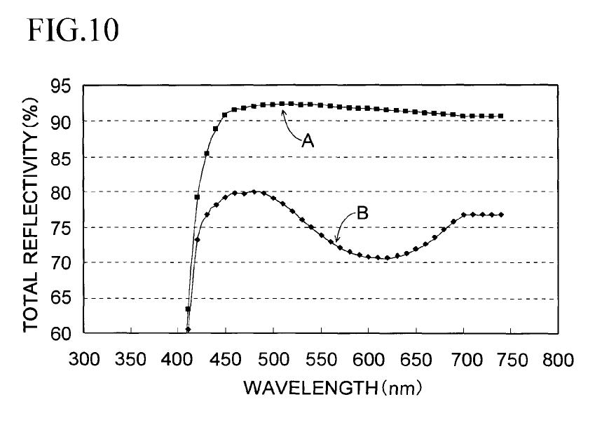

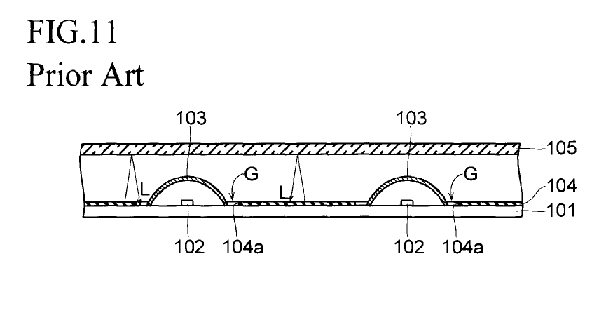

Next, a total reflectivity of a white solder resist containing a high light reflective material and a total reflectivity of a conventional solder resist were measured by using a spectrophotometer (CM-700d) manufactured by Konica Minolta. According to the measurement, as illustrated in FIG. 10, the white solder resist containing a high light reflective material (illustrated by the line A of FIG. 10) was higher in total reflectivity as compared with the conventional solder resist (illustrated by the line B of FIG. 10). For example, in a case where the wavelength is 500 nm, the total reflectivity of the white solder resist containing a high light reflective material and that of the conventional solder resist were about 92% and about 80%, respectively. According to the measurement performed by the inventors of the present invention, unevenness in luminance was not visually recognized as long as the total reflectivity is equal to or more than about 90% in a range of wavelengths from 450 nm to 600 nm, which indicates that it is effective to use the light reflective member 10 formed of a white solder resist containing a high light reflective material to cover a region corresponding to the gap G on the mounting surface of the mounting board 62.

Further, the reflectivity of the white solder resist containing a high light reflective material has a small dependence on wavelength as illustrated in FIG. 10 (line A), and hence an effect of reducing unevenness in chromaticity may be obtained with the use of such a material.

The results described above shows that luminance may be increased while reducing unevenness in luminance according to this embodiment.

Further, the above-mentioned configuration of this embodiment is capable of suppressing a reduction in luminance and an increase in unevenness in luminance, even when the gap G is left between the optical lens 63 and the hole portion 7a of the reflective sheet 7 because the hole portion 7a of the reflective sheet 7 is opened larger in consideration of fluctuations in forming dimension and mounting position of the optical lens 63 (white LED 61) in a case of using one reflective sheet 7 to cover the mounting surfaces of all the mounting boards 62 arranged two-dimensionally. In other words, according to this embodiment, only one reflective sheet 7 is required, and hence the number of man hours and cost for assembling the liquid crystal display device may be reduced.

Still further, according to this embodiment, as described above, the peripheral edge portion of the light reflective member 10 overlaps the inner edge portion of the hole portion 7a of the reflective sheet 7, and hence a region in proximity to the inner edge portion of the hole portion 7a of the reflective sheet 7, on the mounting surface of the mounting board 62, is not exposed, to thereby reduce an area absorbing light.

Still further, according to this embodiment, as described above, the light reflective member 10 has the opening portion 10a formed therein for exposing a region to which the optical lens 63 is fixed on the mounting surface of the mounting board 62, and the opening portion 10a of the light reflective member 10 has a shape formed along a shape of the fixing portion of the optical lens 63. With this configuration, when fixing the optical lens 63 onto the mounting surface of the mounting board 62, the opening portion 10a of the light reflective member 10 serves as a mark to be used for placing the optical lens 63. Accordingly, the optical lens 63 may be positioned with ease.

It should be noted that, according to this embodiment, the light reflective member 10 also has the opening portion 10b formed therein for exposing a region onto which the white LED 61 is mounted on the mounting surface of the mounting board 62. However, the opening portion 10b of the light reflective member 10 has no effect on the ease of positioning of the white LED 61. The reason is as follows. When the white LED 61 is mounted onto the mounting surface of the mounting board 62 (the white LED 61 is fixed onto a land formed on the mounting surface of the mounting board 62) by being subjected to reflow heating using solder, which is a conventional method, the white LED 61 may be mounted with an extremely excellent mounting accuracy by a self alignment effect due to the surface tension of the solder.

It should be construed that the embodiment disclosed in this specification is illustrated by way of example, and is not limitative in all aspects. The scope of the following claims, rather than the above-mentioned embodiment, is to be accorded the broadest interpretation of the present invention so as to encompass all such modifications and equivalent structures and functions.

For example, in the above-mentioned embodiment, the light reflective members 10 are separately arranged in each of the plurality of regions corresponding to the hole portions 7a of the reflective sheet 7, on the mounting surface of the mounting board 62. However, the present invention is not limited thereto. The light reflective member 10 may be arranged across an entire region of the mounting surface of the mounting board 62, and a plurality of the opening portions 10a and a plurality of the opening portions 10b may be formed in the light reflective member 10.

Further, in the above-mentioned embodiment, the light reflective member 10 is formed to be substantially circular in outer shape. However, the present invention is not limited thereto. The light reflective member 10 may be formed to be substantially rectangular in outer shape, or formed to be in any other shape. In any case, however, consideration needs to be given to print precision of the white solder resist containing a high light reflective material, fluctuations in forming dimension of the hole portions 7a of the reflective sheet 7, and mounting tolerance of the reflective sheet 7.

What is claimed is:

1. A backlight unit, comprising:
a substrate;
a light emitting element mounted on a surface of the substrate;
a light diffusing member provided on the surface of the substrate so that the light emitting element is covered with the light diffusing member;
a first light reflective member having a hole portion opened larger in size than an outer shape of the light diffusing member, the first light reflective member being provided on the surface of the substrate while having the light diffusing member protrude from the hole portion so that the first light reflective member covers the surface of the substrate; and
a second light reflective member further provided on the surface of the substrate, the second light reflective member being a member different from the first light reflective member, wherein:
the light diffusing member and the hole portion of the first light reflective member have a gap left therebetween; and
the second light reflective member covers at least a part of a region of the surface of the substrate, the region corresponding to the gap.

2. A backlight unit according to claim 1, wherein the second light reflective member is formed of a material obtained by further adding a predetermined light reflective material to a white solder resist.

3. A backlight unit according to claim 1, wherein the second light reflective member extends from the region on the surface of the substrate, the region corresponding to the gap, to another region on the surface of the substrate, the another region overlapping an inner edge portion of the hole portion of the first light reflective member.

4. A backlight unit according to claim 1, wherein the second light reflective member has an opening portion formed therein, the opening portion being for exposing a region where the light diffusing member is installed on the surface of the substrate.

5. A backlight unit according to claim 4, wherein:
the light diffusing member has a fixing portion fixed onto the surface of the substrate; and
the opening portion of the second light reflective member has a shape formed along a shape of the fixing portion of the light diffusing member.

6. A backlight unit according to claim 1, wherein:
the light emitting element comprises a plurality of light emitting elements and the light diffusing member comprises a plurality of light diffusing members;
the plurality of light emitting elements are arranged two-dimensionally and mounted on the surface of at least one of the substrate, and the plurality of light diffusing members respectively covering the plurality of light emitting elements are provided on the surface of the at least one substrate; and
one of the first light reflective member has a plurality of the hole portion formed therein so that the surface of the at least one substrate is covered with the one first light reflective member.

7. A backlight unit according to claim 1, wherein the light diffusing member comprises an optical lens.

8. A backlight unit according to claim 1, wherein the first light reflective member comprises a reflective sheet.

9. A backlight unit according to claim 1, wherein the light emitting element comprises a white light emitting diode.

10. A display device, comprising:
a display panel; and
a backlight unit for illuminating the display panel, wherein:
the backlight unit includes:
a substrate;
a light emitting element mounted on a surface of the substrate;
a light diffusing member provided on the surface of the substrate so that the light emitting element is covered with the light diffusing member;
a first light reflective member having a hole portion opened larger in size than an outer shape of the light diffusing member, the first light reflective member being provided on the surface of the substrate while having the light diffusing member protrude from the hole portion so that the first light reflective member covers the surface of the substrate; and
a second light reflective member further provided on the surface of the substrate, the second light reflective member being a member different from the first light reflective member;
the light diffusing member and the hole portion of the first light reflective member have a gap left therebetween; and
the second light reflective member covers at least a part of a region of the surface of the substrate, the region corresponding to the gap.
